(19) United States
(12) Patent Application Publication
(10) Pub. No.: US 2012/0019445 A1
(43) Pub. Date: Jan. 26, 2012

(54) KEYBOARD AND INPUT METHOD THEREOF

(75) Inventor: MAN-TIAN LIU, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 12/916,594

(22) Filed: Oct. 31, 2010

(30) Foreign Application Priority Data
Jul. 26, 2010 (CN) 201010236507.9

(51) Int. Cl. G06F 3/02

(52) U.S. Cl. 345/168

(57) ABSTRACT

A keyboard includes a number of buttons, a pedestal, and a processing unit. When sliding on different buttons sequentially by an object such as a figure, the processing unit determines the sliding track and generates signals corresponding to the sliding track to control a cursor displayed on a computer communicating with the keyboard. The keyboard further generates signals to control the computer to execute a left click function and a right click function when an special button is pressed. The present disclosure also provided an input method of the keyboard.

### BACKGROUND

1. Technical Field

The present disclosure relates to keyboards and input methods and, particularly, to a keyboard with mouse function and an input method thereof.

2. Description of Related Art

Conventionally, a keyboard and a mouse are separate components, and it is often inconvenient for users to switch back and forth between them.

Therefore, it is desirable to provide a new keyboard with mouse function, which can overcome the above-mentioned limitations.

### BRIEF DESCRIPTION OF THE DRAWINGS

Many aspects of the present disclosure should be better understood with reference to the following drawings. The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is a schematic view of a keyboard according to an exemplary embodiment.

FIG. 2 is an exploded, perspective view of a button of the keyboard of FIG. 1.

FIG. 3 is an isometric view of the button of FIG. 2.

FIG. 4 is a schematic view of a pedestal of the keyboard of FIG. 1.

FIG. 5 is a cross-sectional view of the key and the key pedestal of the keyboard of FIG. 1.

FIG. 6 is a block diagram of main function modules implemented by a processing unit of the keyboard of FIG. 1.

FIG. 7 is a flowchart of an input method in accordance with an exemplary embodiment.

### DETAILED DESCRIPTION

Embodiments of the present disclosure will now be described in detail below, with reference to the accompanying drawings.

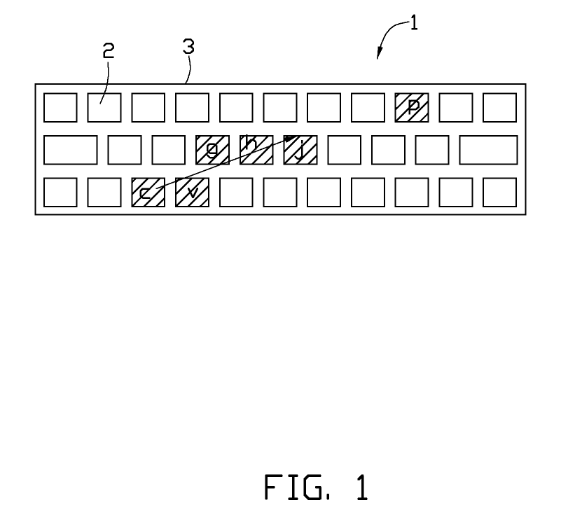

Referring to FIG. 1, the keyboard 1 includes a number of buttons 2. When a user applies a sliding touch on different buttons 2 in sequence with an object such as a finger or a stylus, the keyboard 1 determines the sliding track and generates signals corresponding to the sliding track to control movement of a cursor displayed on a computer screen of a computer (not shown) communicating with the keyboard 1. The keyboard 1 can further generate a left click control signal for controlling the computer to execute the left click function, and generate a right click control signal for controlling the computer to execute the right click function. Specifically, the keyboard 1 generates the left click control signal to control the computer to execute the left click function if the duration of pressing a special button of the keyboard 1 reaches a first predetermined time interval, and generates the right click signal to control the computer to execute the right click function if the duration of pressing the special button of the keyboard 1 reaches a second predetermined time interval.

For better understanding the present disclosure, the buttons labeled c, v, g, h, j, and p are used to provide an example, and the button p is the special button. If the user applies a sliding touch on the buttons labeled c, v, g, h, and j sequentially, the keyboard 1 determines the sliding track and generates signals corresponding to the sliding track to control the movement of the displayed cursor. The p button can be used to activate any one of three functions. Which function is performed is determined by how long a user presses the p button. If the user presses the p button less than time t then the ordinary function of entering the letter p is performed. If the button is pressed for at least time t but less than time t₁, a left click control signal identical to the left click control signal of a standard mouse would generate is sent to the computer to execute the left click function. If the user presses the button p for at least time t₁, a right click control signal identical to the right click control signal of a standard mouse would generate is sent to the computer to execute the right click function. In this embodiment t is less than t₁. Values for t and t₁ may be set as desired and associated with functions as desired in embodiments.

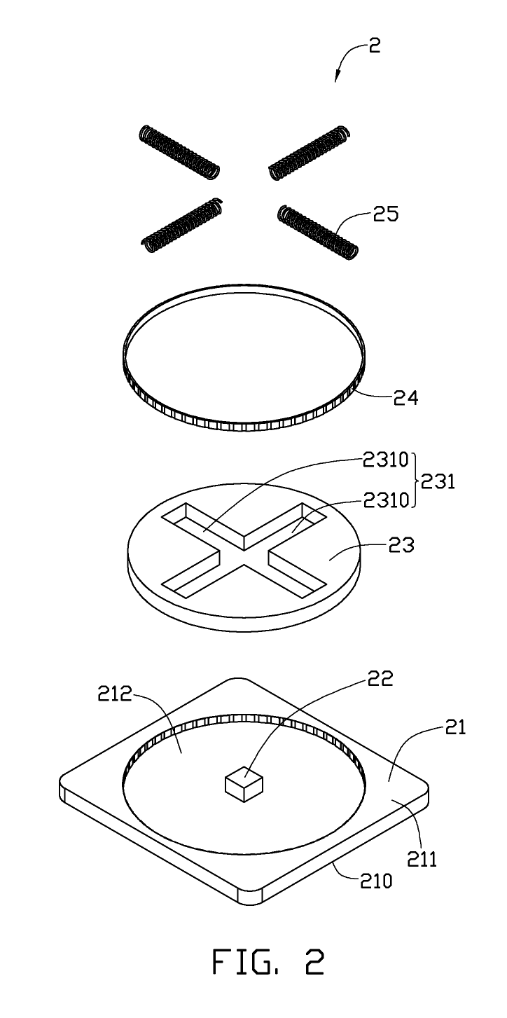

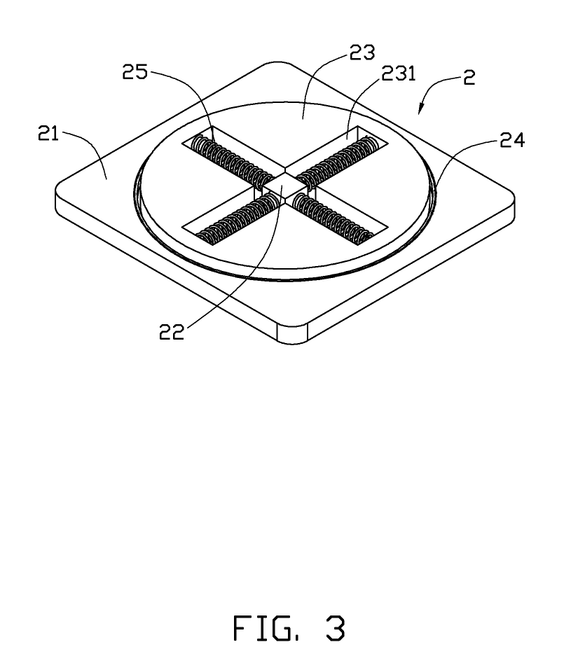

Referring to FIGS. 2-3, each button 2 includes a main body 21, a movable member 23, a first electrode member 24, and a number of elastic members 25. In this embodiment, the elastic members 25 are coil springs.

A top surface 210 of the main body 21 is exposed to the keyboard 1 for users to operate. A bottom surface 211 opposite to the top surface 210 defines a recessed portion 212. A protrusion 22 protrudes from the bottom surface of the recessed portion 212. In this embodiment, the recessed portion 212 is substantially circular, and the protrusion 22 is in the middle of the recessed portion 212.

The movable member 23 defines a slot 231 extending through the movable member 23. The slot 231 is substantially cross shaped and the arms of the cross are four sub-slots 2310 communicating with each other. In this embodiment, the movable member 23 is substantially circular. The diameter of the moveable member 23 is less than that of the recessed portion 212, and the moveable member 23 is moveably received in the recessed portion 212. The protrusion 22 is moveably received in the center of the slot 231.

The first electrode member 24 is substantially annular. The diameter of the first electrode member 24 is the same as that of the movable member 23, and the first electrode member 24 is securely arranged over the sidewall of the movable member 23.

In this embodiment, four springs 25 are deployed and each is mounted in one sub-slot 2310 with opposite ends respectively resisting a sidewall of the sub-slot 2310 and the protrusion 22.

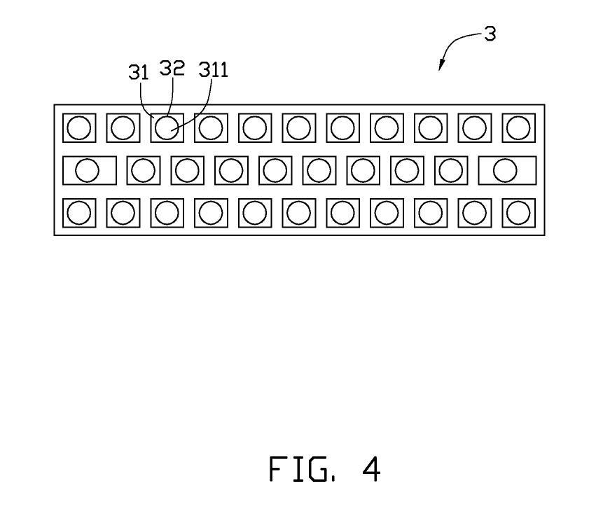

Referring to FIG. 4, the keyboard 1 further includes a pedestal 3 defining a number of button bases 31 and including a number of second electrode members 32.

Each base 31 defines a recessed portion 311 to receive the second electrode member 32 and a portion of the moveable member 23. In this embodiment, the second electrode member 32 is substantially annular, and the recessed portion 311 is substantially circular. The first electrode member 24 of one button 2 and the second electrode 32 received in the base 31 supporting the button 2 are concentric and cooperatively form a capacitor.

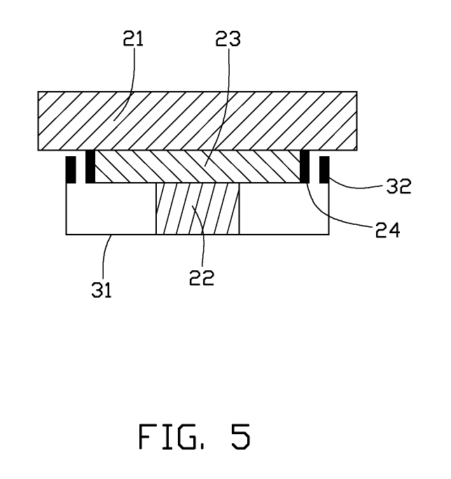

Referring to FIG. 5, sliding on the button 2 moves the body 21 and the protrusion 22, causing the protrusion 22 to compress one elastic member 25 to move the movable member 23. The relative position of the first electrode member 24 relative to the second electrode member 32 is thus changed and the capacitance value of the capacitor accordingly changes.

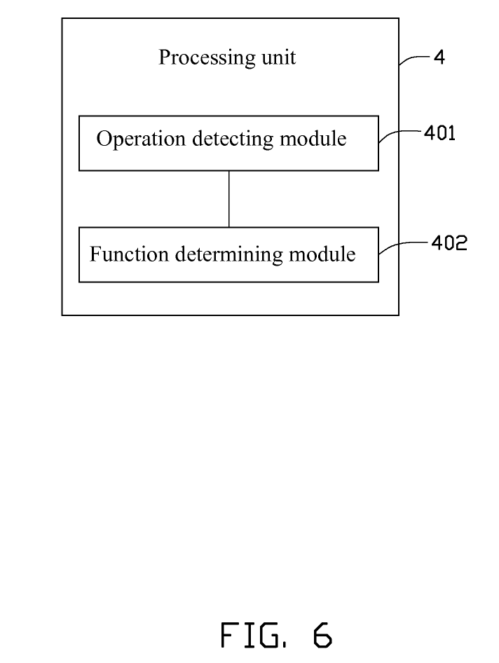

Referring to FIG. 6, the keyboard 1 further includes a processing unit 4. The processing unit 4 includes an operation detecting module 401 and a function determining module 402. The operation detecting module 401 is configured to determine that a sliding operation is exerted on the keyboard 1 upon detecting change in capacitance values of at least two adjacent capacitors and determine the sliding track corresponding to the sliding operation. The function determining module 402 is configured to generate signals corresponding to the sliding track to control movement of the displayed cursor. The function determining module 402 is further configured to generate signals to control the computer to execute the left and right click functions when the special button is pressed as explained above.

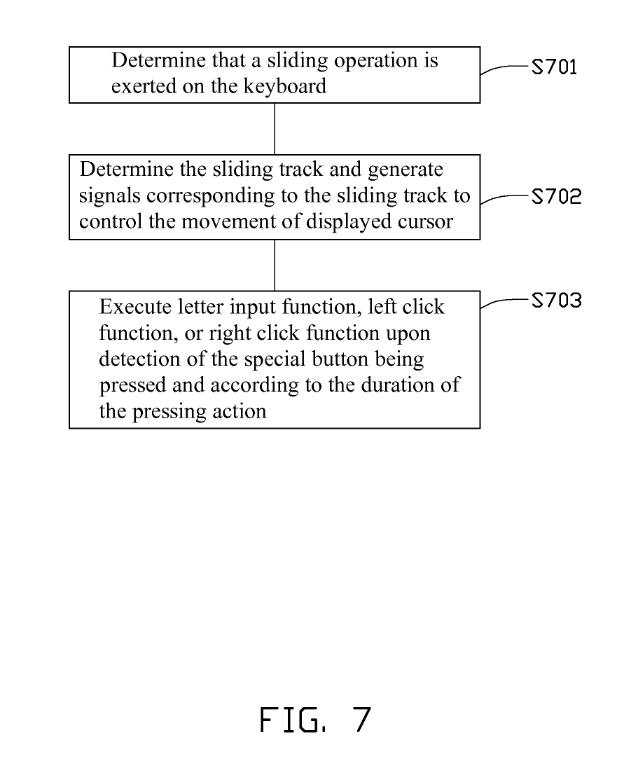

Referring to FIG. 7, an input method of the keyboard 1 in accordance with an exemplary embodiment is illustrated.

In step S701, the processing unit 4 determines that a sliding operation is exerted on the keyboard 1 upon detecting change in capacitance value of at least two adjacent capacitors.

In step S702, the processing unit 4 determines the sliding track corresponding to the sliding operation and generates signals corresponding to the sliding track to control movement of the displayed cursor.

In step S703, the processing unit 4 generates signals to control the computer to execute letter input function, left click function, or right click function upon detection of the special button being pressed and according to the duration of the pressing action.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. A keyboard comprising:
a plurality of buttons each of which comprising a first electrode member;
a pedestal comprising a plurality of button bases and a plurality of second electrode members, wherein each of the button bases is configured to receive one of the buttons and one of the second electrode members, each of the first electrode members and one of the second electrode members cooperatively form a capacitor; and
a processing unit to determine that a sliding operation is exerted on the keyboard upon detecting change in capacitance values of at least two adjacent capacitors, and determine the sliding track corresponding to the sliding operation and generate signals corresponding to the sliding track to control the movement of a cursor displayed on a computer communicating with the keyboard.

2. The keyboard according to claim 1, wherein the processing unit is further to generates signals to control the computer to execute letter input function, left click function, or right click function upon detection of the special button being pressed and according to the duration of the pressing action.

3. The keyboard according to claim 1, wherein each of the buttons further comprises a main body and a moveable member, a bottom surface of the main body defines a recessed portion, the moveable member is movably received in the recessed portion, and the first electrode member is securely arranged over the sidewall of the movable member.

4. The keyboard according to claim 3, wherein each of the buttons further comprises a number of elastic members, the movable member defines a slot extending through the movable member, the slot comprises a number of sub-slots communicating with each other, a protrusion protrudes from the bottom surface of the recessed portion and is moveably received in the center of the slot, each of the elastic members is received in one of the sub-slots with two opposite ends respectively resisting a sidewall of the one of the sub-slots and the protrusion.

5. The keyboard according to claim 4, wherein the recessed portion and the movable member are substantially circular, and the first electrode member and the second elastic member are substantially annular.

6. An input method applied in a keyboard, the keyboard comprising a plurality of buttons and a pedestal, each of the buttons comprising a first electrode member, the pedestal comprising a plurality of buttons bases and a plurality of second electrode members, each of the button bases being configured to receive one of the buttons and one of the second electrode members, each of the first electrode members and one of the second electrode members cooperatively form a capacitor, the method comprising:
determining that a sliding operation is exerted on the keyboard upon detecting change in capacitance values of at least two adjacent capacitors; and
determining the sliding track corresponding to the sliding operation and generating signals corresponding to the sliding track to control the movement of a cursor displayed on a computer communicating with the keyboard.

7. The input method according the claim 6, further comprising:
executing letter input function, left click function, or right click function upon detection of the special button being pressed and according to the duration of the pressing action.
